(19) United States
(12) Patent Application Publication
(10) Pub. No.: US 2004/0189444 A1
(43) Pub. Date: Sep. 30, 2004

(54) Maintenance interval timer and method of monitoring maintence intervals

(76) Inventor: Andrew M. Gill, Brentwood, TN (US)

Correspondence Address: DAVID M. LAFKAS, 7811 LAUREL AVENUE, CINCINNATI, OH, 45243, US

(21) Appl. No.: 10/403,607

(22) Filed: Mar. 31, 2003

(51) Int. Cl. G08B 1/00

(52) U.S. Cl. 340/309.16

(57) ABSTRACT

The present invention relates to a timing device for determining maintenance intervals of maintenance-sensitive equipment. The timing device has a casing, an integrated circuit, a liquid crystal display connecting to the integrated circuit, a light emitting diode connecting to the integrated circuit, a power source connecting to the integrated circuit, a starting means, and a fixing means. The device measures a predetermined period of time and alerts a user when the predetermined period of time is achieved or soon to be achieved. The invention also relates to a method of monitoring maintenance intervals of maintenance-sensitive equipment.

### BACKGROUND OF THE INVENTION

1. Field of the Invention

The invention relates to a monitoring of and an alerting of a pre-determined time interval at which time maintenance-sensitive equipment requires a scheduled maintenance review.

2. Discussion of the Prior Art

There has been an exponential growth in the development and use of technologically advanced equipment and instruments throughout varying industries and society. Typically, however, such equipment and instruments are often not maintenance free. Rather, the equipment and instruments require ongoing evaluation and preventative maintenance at scheduled time intervals to ensure accurate and precise functioning. Equipment and instruments of this sort and are defined herein as “maintenance-sensitive equipment.” It is possible that under some circumstances, if scheduled evaluations and preventive maintenances are missed on maintenance-sensitive equipment, lives can be at risk.

A primary example of maintenance-sensitive equipment includes medical equipment used in hospitals and other medical facilities. Such maintenance-sensitive equipment is used by the medical community, for example, to examine patients for appropriate care, diagnose patients, deliver fluids, and remedy the patients' ill health.

Maintenance-sensitive equipment is often not stationary, and may be prone to be moved throughout a facility or between one or more different facilities.

For example, medical equipment in a hospital may typically move from room to room, floor to floor, or between departments depending on where the patient to which the medical equipment is attached or being used is moved. Further, the priority by which the equipment is needed may change between rooms, floors or departments such that the equipment is moved to assist other patients and/or needs.

Maintenance-sensitive equipment may also be moved and/or hidden by well-intentioned employees who are partial to using a particular piece of maintenance-sensitive equipment. Further, such employees may be motivated to ensuring that they have immediate and unencumbered access to particular maintenance-sensitive equipment needed to competently and professionally perform their role. In the case of the medical community, for example, it is not uncommon for nurses and technicians to hide essential care-giving and diagnostic equipment and instruments, only to reveal the hidden equipment and instruments when the particular nurse or technician determines that it is necessary.

As maintenance-sensitive equipment are often not adequately tracked or are simply unable to be tracked, a scheduled evaluation and preventative maintenance may be missed, thereby resulting in unsafe and/or flawed modes of the maintenance-sensitive equipment.

Prior methods of monitoring the scheduled maintenance of maintenance-sensitive equipment include human memory and typical calendar/docketing systems. Calendar and docketing systems typically involve a central or regional calendar by which a user would identify on a calendar when the scheduled maintenance of particular maintenance-sensitive equipment should occur, and tracking down and performing the scheduled maintenance on the particular maintenance-sensitive equipment when it is shown in the calendar.

The calendar and docketing system, however, fails to adequately track maintenance-sensitive equipment that is moveable. Further, a user of maintenance-sensitive equipment is not likely to take the time and trouble to cross-check a particular piece of maintenance-sensitive equipment with a calendar and docketing system before each use of the equipment.

Other systems have been employed that require a central computer system that remotely monitors and gathers data from a plurality of equipment. See, for example, U.S. Pat. No. 6,487,513 to Eastvold et al. and U.S. Pat. No. 5,807,336 to Russo et al. Such systems, however, are expensive and do not remedy the problem associated when maintenance-sensitive equipment is moved out of the range of the central computer or monitoring devices.

Thus, what is needed is an affordable means by which one can accurately and precisely monitor the evaluation and preventative maintenance schedules of any and all maintenance-sensitive equipment in order to ensure that the maintenance-sensitive equipment is used in a safe manner, for example, is within calibration standards, which could otherwise result in catastrophe due to inaccuracies in metering, reading or interpretation of data provided from the maintenance-sensitive equipment.

### SUMMARY OF THE INVENTION

Various exemplary embodiments of the present invention include a timing device for determining maintenance intervals of maintenance-sensitive equipment, comprising a casing, an integrated circuit, a liquid crystal display connecting to the integrated circuit, a light emitting diode connecting to the integrated circuit, a power source connecting to the integrated circuit, a starting means, and a fixing means. The device measures a predetermined period of time and alerts a user when the predetermined period of time is achieved or soon to be achieved.

The various exemplary embodiments of the present invention further include a method for monitoring maintenance intervals of maintenance-sensitive equipment, comprising adhering a device to the maintenance-sensitive equipment, wherein the device comprises a casing, an integrated circuit, a liquid crystal display connecting to the integrated circuit, a light emitting diode connecting to the integrated circuit, a power source connecting to the integrated circuit, a starting means, and a fixing means. The device is initiated by the starting means in order to measure a predetermined period of time, the liquid crystal display is observed to see a time relative to the predetermined period of time and then maintenance is performed on the maintenance-sensitive equipment when the light emitting diode lights up to alert that the predetermined period of time is achieved or soon to be achieved.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a schematic representation of a front view of a maintenance interval timing device according to the various exemplary embodiments of the present invention.

FIG. 2 is a schematic representation of a side view of a maintenance interval timing device according to the various exemplary embodiments of the present invention.

### DETAILED DESCRIPTION OF THE INVENTION

FIG. 2 illustrates aspects of the various exemplary embodiments of the present invention wherein a liquid crystal display (LCD) 220, light emitting diode (LED) 230 and starting means 240 are on a front side 205 of a maintenance interval timing device 200. A fixing means 250 is on a back side 207 of the timing device 200.

The fixing means 250 adheres the timing device 200 to maintenance-sensitive equipment that a user desires to monitor for a next-scheduled evaluation and/or preventative maintenance. The fixing means is selected from the group consisting of glue, double-sided tape, and one or more screws. Preferably, the fixing means is double sided tape.

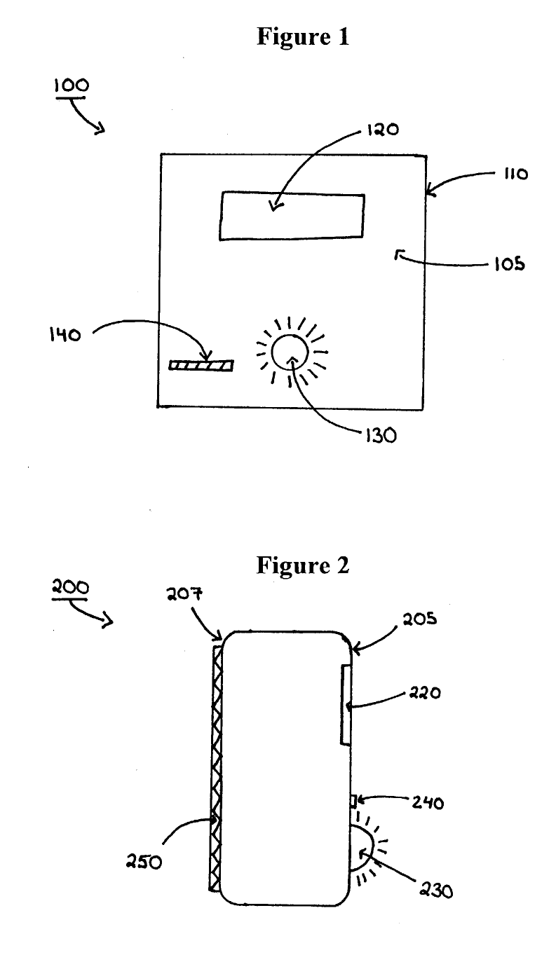

FIG. 1 illustrates a maintenance interval timing device 100 according to the various exemplary embodiments of the present invention. A casing 110 of the various exemplary embodiments of the present invention comprises an outer shell of the timing device. The casing illustrated in FIG. 1 is rectangular in shape, however, it should be readily understood that the casing may be of any geometrical shape desired including, for example, but not limited to, a circle, a trapezoid, a triangle, a hexagon, and the like. The casing of the various exemplary embodiments of the present invention is composed of plastic, rubber, metal, alloy, ceramic, or mixtures thereof. Preferably, in the various exemplary embodiments of the present invention, the casing comprises a plastic.

In the various exemplary embodiments of the present invention, the casing 110 surrounds an integrated circuit (not shown). The integrated circuit is preferably connected to an liquid crystal display (LCD) 120, a light emitting diode (LED) 130 and a starting means 140. The LCD 120, LED 130 and starting means 140 are all visible on the exterior of the casing in the various exemplary embodiments of the present invention. In a preferred embodiment, the LCD 120 shows a predetermined time relative to a next-scheduled regular evaluation and/or preventative maintenance. The time shown by the LCD can be shown as any time interval including, for example, years, months, days, hours, minutes, or seconds. Preferably, the time shown by the LCD is shown as days.

Further, in the various exemplary embodiments of the present invention, the LCD may show a message to the user as a text message or as one or more symbols, i.e., universally recognized symbols or symbols created for the timing device, indicating the functioning of the timing device.

In the various exemplary embodiments of the present invention, the LCD, for example, shows the time remaining until the next-scheduled evaluation and/or preventative maintenance, the time since a last performed evaluation and/or preventative maintenance, the date of the next-scheduled evaluation and/or preventative maintenance, the date of the last-performed evaluation and/or preventative maintenance, or combinations thereof. Preferably, the LCD of the various exemplary embodiments of the present invention shows the time remaining until the next-scheduled evaluation and/or preventative maintenance, i.e., the LCD shows the measured time interval to the next-scheduled evaluation and/or preventative maintenance as a reverse countdown.

In the various exemplary embodiments wherein the LCD shows the measured time interval as a reverse countdown, the initial time value shown by the LCD is preferably the value of the predetermined time interval. For example, if the predetermined time interval is 360 days, at the time the timing device is initiated, the LCD preferably shows a time value of 360. Preferably, as time passes, the amount of time until the next-scheduled evaluation and/or preventative maintenance will become smaller and approach a value of zero (0).

In the various exemplary embodiments of the present invention, when the predetermined time interval is reached, that is, for example, when the LCD of the timing device as a reverse countdown shows a value of zero, the LCD preferably continues showing the amount of time since the predetermined time interval was reached as a negative number. For example, if a predetermined time interval was reached a week prior, the LCD shows, for example, a negative seven (−7) to represent that seven days have passed since the predetermined time interval elapsed.

In the various exemplary embodiments of the present invention, the LCD 120 connects to the LED 130 by way of the integrated circuit (not shown). The LED 130 is not lit, i.e., the integrated circuit does not supply power to the light such that it emits visible light, until the time interval shown by the LCD display reaches the predetermined period of time or a set amount of time before the predetermined period of time. That is, the user is alerted of the time relative to the predetermined period of time. Once the predetermined period of time is reached or a set amount of time before the predetermined period of time, the LED lights up to provide an indication to a potential user that the maintenance-sensitive equipment to which the timing device is adhered is due for a scheduled evaluation and/or preventative maintenance and thus the maintenance-sensitive equipment should not be used. Thus, for example, if a set amount of time is about five days before the predetermined period of time, the LED may begin to light up about five days before the predetermined period of time is reached.

The LED of the various exemplary embodiments of the present invention lights up as a steady visible light, flashes or pulses in a regular or irregular fashion. Preferably, the LED light flashes to alert a user that the time for the scheduled evaluation and/or preventative maintenance of the associated maintenance-sensitive equipment is soon to be achieved, i.e., for example, that the set amount of time before the predetermined period of time is met. The LED light can be of any visible color.

In the various exemplary embodiments of the present invention, the integrated circuit (not shown) is preferably powered by a battery (not shown), i.e., DC power, in the various exemplary embodiments of the present invention. The battery is also surrounded by the casing 110. A starting means initiates power to be supplied to the integrated circuit and the LCD such that the display begins showing the time relative to a next-scheduled regular evaluation and/or preventative maintenance.

The starting means is preferably a button or a pull-tab in the various exemplary embodiments of the present invention. More preferably, the starting means is a pull tab. Preferably, the pull tab is a disposable tab comprising paper, plastic or mixtures thereof, that, when not pulled, inhibits contact and/or connection between the power source and the integrated circuit.

In the various exemplary embodiments of the present invention, the starting means is a pull tab, wherein the pull tab is located between the battery and integrated circuit when the integrated circuit is not powered. However, when the pull tab is removed or pulled out far enough that contact or connection is made between the battery and integrated circuit, the LCD display begins to show the time relative to a next-scheduled regular evaluation and/or preventative maintenance.

In the various exemplary embodiments of the present invention, upon initiation of the starting means, the time relative to the next-scheduled regular evaluation and/or preventative maintenance cannot be reset or restarted.

In the various exemplary embodiments of the present invention, the timing device is disposable.

Maintenance-sensitive equipment is preferably monitored for scheduled evaluations or preventative maintenance by adhering the timing device of the various exemplary embodiments according to the present invention to maintenance-sensitive equipment to be monitored. Once the timing device of the present various exemplary embodiments of the present invention is adhered to the equipment or instrument, the starting means is initiated such that power is supplied to the integrated circuit. Thus, the integrated circuit begins counting to a predetermined time and shows the time remaining or past on the LCD display. Once the predetermined time interval has elapsed or a set amount of time before the predetermined time interval is reached, the LED lights up to provide notice that the associated maintenance-sensitive equipment requires scheduled evaluation and/or preventative maintenance before the associated maintenance-sensitive equipment undergoes further use.

When the predetermined time interval has elapsed or a set amount of time before the predetermined period of time, the LCD can, for example, display or flash a message to the user, continue counting up, or continue counting backwards as negative numbers (i.e., the time since the predetermined time interval was reached).

Upon completion of the regular evaluation and/or preventative maintenance, the timing device of the present various exemplary embodiments of the present invention is removed and replaced with an unused timing device of the present various exemplary embodiments of the present invention, i.e., the starting means has not been initiated. Once the unused device is adhered to the equipment or instrument, the starting means is initiated and the timer again counts to a predetermined time at which the next regular evaluation and/or preventative maintenance is performed.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

What is claimed is:

1. A timing device for determining maintenance intervals of maintenance-sensitive equipment, comprising:
a casing;
an integrated circuit;
a liquid crystal display connecting to the integrated circuit;
a light emitting diode connecting to the integrated circuit;
a power source connecting to the integrated circuit;
a starting means; and
a fixing means,
wherein the device measures a predetermined period of time and alerts a user of a time relative to the predetermined period of time.

2. The device according to claim 1, wherein the maintenance-sensitive equipment is medical equipment.

3. The device according to claim 1, wherein the device measures the predetermined period of time in reverse starting from a higher numerical value and counting to a lower numerical value.

4. The device according to claim 1, wherein the liquid crystal display shows a time interval.

5. The device according to claim 4, wherein the time interval is an amount of time remaining until the predetermined period of time is achieved.

6. The device according to claim 4, wherein the liquid crystal display shows a target date.

7. The device according to claim 1, wherein the liquid crystal display shows a text message, one or more symbols, or a combination thereof.

8. The device according to claim 1, wherein the light emitting diode lights up to alert the user when a set period of time before the predetermined period of time is reached.

9. The device according to claim 1, wherein the light emitting diode lights up to alert the user when the predetermined period of time is reached.

10. The device according to claim 1, wherein the power source is a battery.

11. The device according to claim 1, wherein the starting means is a pull tab.

12. The device according to claim 11, wherein the pull tab comprises plastic, paper or a combination thereof.

13. The device according to claim 1, wherein the fixing means is on a back side of the device.

14. The device according to claim 1, wherein the fixing means is selected from the group consisting of an adhesive, double-sided tape and one or more screws.

15. A method for monitoring maintenance intervals of maintenance-sensitive equipment, comprising
adhering a device to the maintenance-sensitive equipment, wherein the device comprises:
a casing,
an integrated circuit,
a liquid crystal display connecting to the integrated circuit,
a light emitting diode connecting to the integrated circuit,
a power source connecting to the integrated circuit,
a starting means, and
a fixing means;
initiating the integrated circuit via the starting means to measure a predetermined period of time;
observing on the liquid crystal display a time relative to the predetermined period of time; and
performing maintenance on the maintenance-sensitive equipment when the light emitting diode lights up.

16. The method according to claim 15, wherein the maintenance-sensitive equipment is medical equipment.

17. The method according to claim 15, wherein the device measures the predetermined period of time in reverse starting from a higher numerical value and counting to a lower numerical value.

18. The method according to claim 15, wherein the liquid crystal display shows a time interval.

19. The method according to claim 18, wherein the time interval is an amount of time remaining until the predetermined period of time is achieved.

20. The method according to claim 15, wherein the light emitting diode lights up when a set period of time before the predetermined period of time is reached.
